(19) United States
(12) Patent Application Publication
(10) Pub. No.: US 2013/0019892 A1
(43) Pub. Date: Jan. 24, 2013

(54) DEVICE AND METHOD FOR HEATING HAIR CURLERS

(71) Applicants: Maggie Cheung, Hong Kong (HK); Kwong Cheung, Hong Kong (HK)

(72) Inventors: Maggie Cheung, Hong Kong (HK); Kwong Cheung, Hong Kong (HK)

(21) Appl. No.: 13/483,127

(22) Filed: May 30, 2012

Related U.S. Application Data
(63) Continuation-in-part of application No. 13/187,655, filed on Jul. 21, 2011.
(60) Provisional application No. 61/584,923, filed on Jan. 10, 2012.

(51) Int. Cl. A45D 2/36; H05B 6/10

(52) U.S. Cl. 132/229; 219/635

(57) ABSTRACT

A hair curler heating system, is disclosed comprising a hair curler having an induction core, a plastic cage surrounding the core, a conductive conical member surrounding the cage, and an outer plastic conical member having frictional conducting material on its exterior. There is a housing for receiving said curler and for heating it therein. The housing includes an induction coil, a control circuit operatively connected to the coil, a resonant capacitor operatively connected to the circuit, a heat sink connected to the capacitor, and a colored heating indication panel attached to the housing and operatively connected to the circuit.

### CROSS REFERENCE TO RELATED APPLICATIONS

This application claims priority to copending provisional application 61/584,923, filed Jan. 10, 2012, which is incorporated herein in its entirety by reference. This application is a continuation-in-part of copending application Ser. No. 13/187,655 filed Jul. 21, 2012, which is incorporated herein in its entirety by reference.

### BACKGROUND OF THE INVENTION

1. Field of the Invention

The present invention generally relates to a novel type of hair curler. Specifically, the present invention relates to a device and method for heating hair curlers. In particular, the present invention relates to an aesthetically pleasing system for professional and consumer use for heating rollers used for curling hair that is safe, easy, and quick to use. As used herein, ther terms “rollers” and “curlers” may be used interchangeably, as one of skill in the art will readily recognize.

2. Description of the Related Art

Conventional hair curling roller sets usually have one base set with all of the rollers lined up in the heating station. Typically, one turns on the heating station and the entire set of rollers heat up at the same time. The rollers cannot be used until the maximum temperature has been reached, which can take from 2 to 5 minutes. Once the rollers are hot, they are removed from the heater and hair is round about them.

Having a small army of heated rollers in a heating station, whether at home or at a salon is dangerous to both professionals and the consumer. The rollers can be upended or knocked over with the result of persons and items burned by the heated rollers. Further, the heating station also heats up, which can also be a safety hazard for home use, especially if there are young children in the household.

There is therefore a great need in the art for an aesthetically pleasing system for professional and consumer use for heating rollers used for curling hair that is safe, easy, and quick to use. Accordingly, there is now provided with this invention an improved device and method for heating hair curlers effectively overcoming the aforementioned difficulties and longstanding problems inherent in heating hair curling rollers. These problems have been solved in a simple, convenient, and highly effective way by which to heat the hair curlers.

### SUMMARY OF THE INVENTION

According to one aspect of the invention, a hair curler is disclosed comprising a first conical member having slits extending therearound a second conical member fitting substantially within the first conical member consisting essentially of silicon, and a third conical member fitting substantially within the second conical member comprising a ferro-magnetic material. A first end cap fits on the end of the first conical member having substantially concentric slits therein and a second end cap fits on the end of the third conical member having substantially concentric slits therein.

According to another aspect of the invention, a hair curler is disclosed comprising a first conical member comprising a high frictional and conducting material therearound, a second conical member fitting substantially within said first conical member comprising a conducting material, a third conical member fitting substantially within said second conical member comprising a high heat plastic polymer, a fourth conical member fitting substantially within said third conical member comprising an induction material, a fifth conical member fitting substantially within said fourth conical member comprising an aluminum film; and an end cap fitting on the end of the hair curler.

According to still another aspect of the invention, a hair curler heater is disclosed comprising an upper, middle, and lower housing. An induction coil is positioned between the upper and the middle housing and a control circuit is operatively connected to the coil. A resonant capacitor is positioned between the middle and the lower housing. A heat sink is connected to the capacitor and a colored heating indication panel is attached to the upper housing and operatively connected to the control circuit.

According to yet another aspect of the invention, a hair curler heating system, is disclosed comprising a hair curler having a ferro-magnetic core, a plastic outer shell, an insulator therebetween, and a housing for receiving said curler and for heating it therein. The housing includes an induction coil, a control circuit operatively connected to the coil, a resonant capacitor operatively connected to the circuit, a heat sink connected to the capacitor, and a colored heating indication panel attached to the housing and operatively connected to the circuit.

Additional objects of the present invention will become apparent from the following description.

The method and apparatus of the present invention will be better understood by reference to the following detailed discussion of specific embodiments and the attached figures which illustrate and exemplify such embodiments.

### DESCRIPTION OF THE DRAWINGS

A specific embodiment of the present invention will be described with reference to the following drawings, wherein:

FIG. 1 is an orthogonal top view of the curler heater of the present invention.

FIG. 2 is a side view of the curler heater of the present invention.

FIG. 3 is an exploded view of the curler heater of the present invention.

FIG. 4 is a sectional side view of the curler heater of the present invention.

FIG. 5 is an electrical schematic drawing of the system of the present invention.

FIG. 6 is an exploded view of the curler of the present invention.

FIG. 7 is an exploded view of another embodiment of the curler of the present invention.

FIG. 8 is an exploded view of yet another embodiment of the curler of the present invention.

### DESCRIPTION OF THE PREFERRED EMBODIMENT

The following preferred embodiment as exemplified by the drawings is illustrative of the invention and is not intended to limit the invention as encompassed by the claims of this application. A device and method for heating hair curlers is disclosed herein.

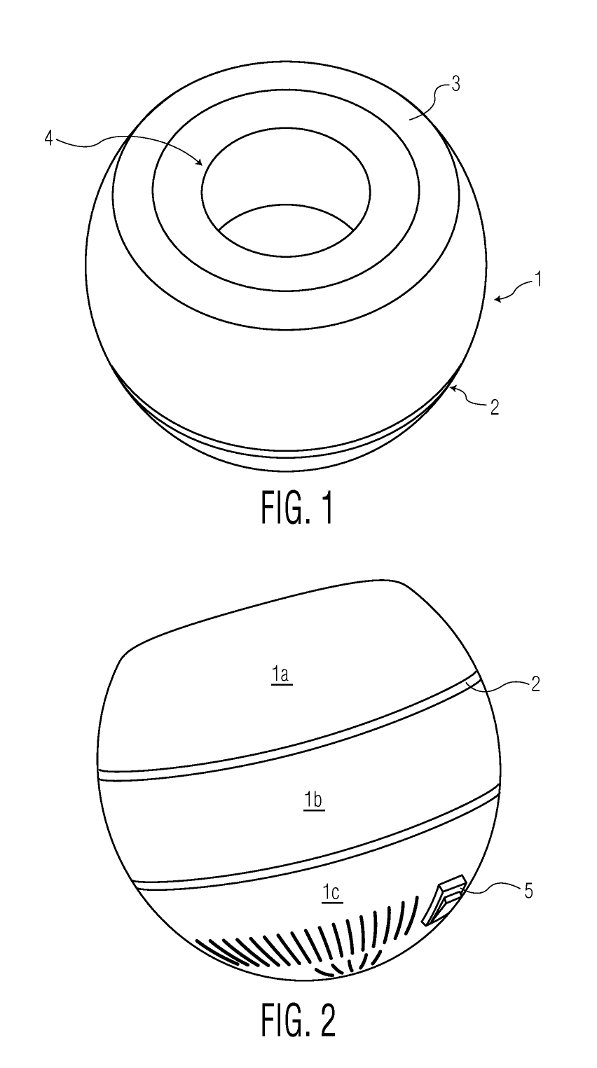

The curler heater of the present invention 1, as illustrated in FIGS. 1-4 shows an upper housing 1a, typically having a diameter of 185 mm, a middle housing 1b, typically having a diameter of 185 mm or 175 mm, with height of 35 mm, and a lower housing 1c, typically having a diameter of 175 mm. A silicon ring, typically an o-ring, separates the housings from each other.

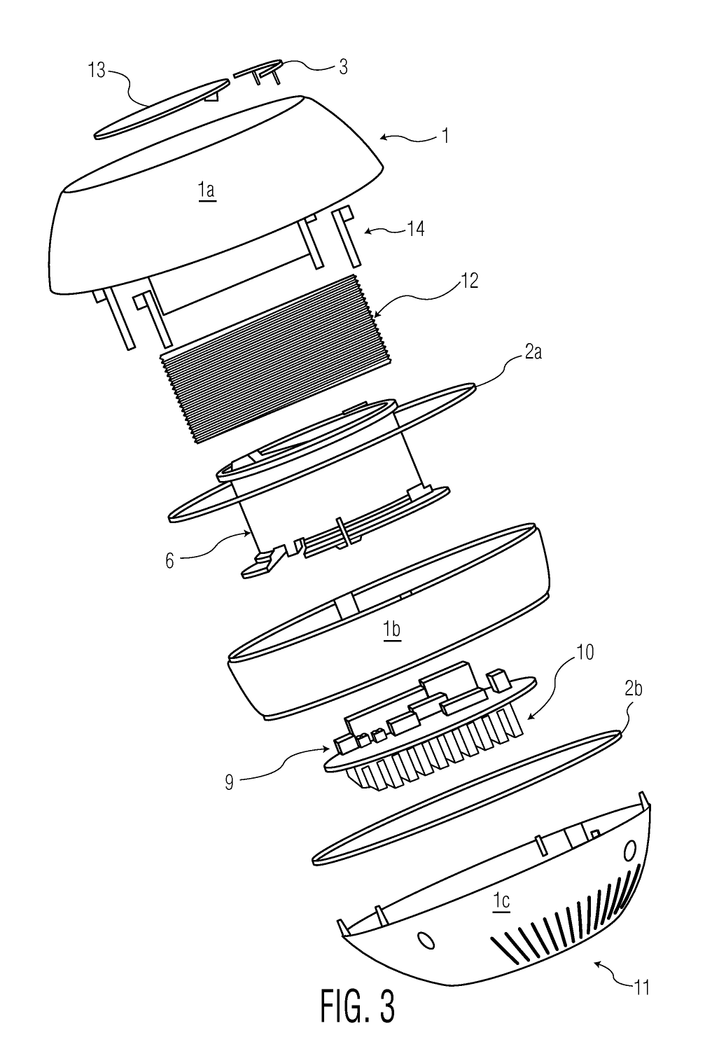

As specifically illustrated in FIG. 3, a first silicon ring 2a separates the upper housing 1a from the middle housing 1b and another, second silicon ring 2b separates the middle housing 1b from the lower housing 1c. Screws 14 connect the housings together.

A heating indication panel 3 is attached to the upper housing 1a. The indication panel 3 may be one or many LEDs. Typically, this indication panel 3 indicates the sufficiency of heat applied to a curler by a color-coded indication. For example, it may indicated that a curler is sufficiently heated by turning green. Alternatively, it may display a red color when power is applied and thereafter turn green when a curler is sufficiently heated. A further alternative may include a range of colors or indication lights showing a gradation of temperature achieved by the curler. For example, a 4 color changing indicator 13 may be used which tells the user how much heat energy the roller has left, making predictable judgments for hair styling purposes. When all 4 sections change color, the curler has reached its maximum temperature. Three illuminated sections may mean the curler has reached 75% of heat output. Two 2 illuminated sections may mean the curler has reached 50% of heat output. If only the last section is lit, it may mean that the curler has reached 25% of heat output.

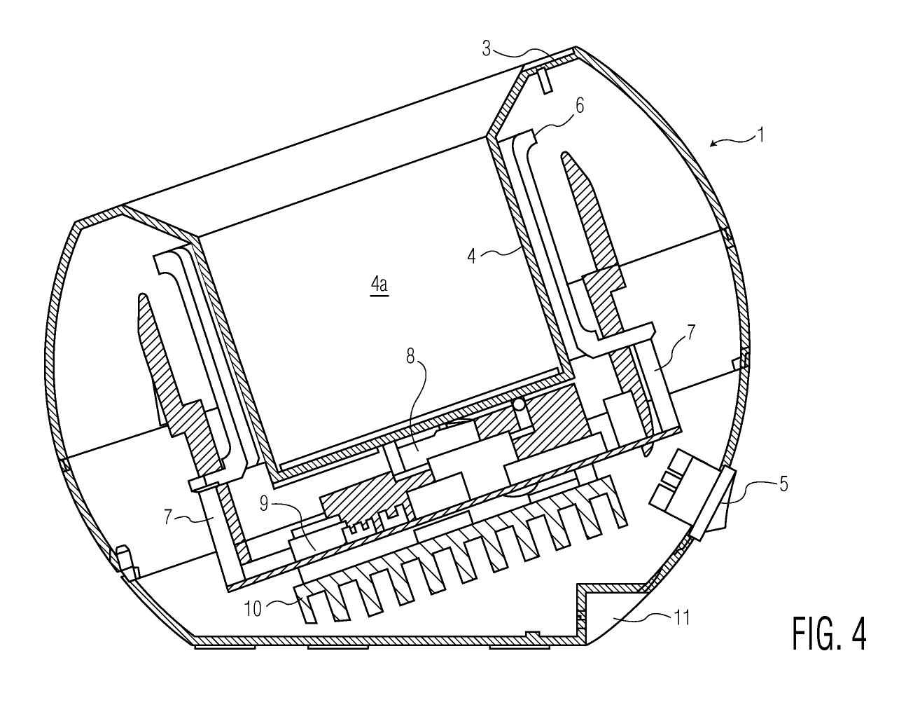

As shown specifically in FIG. 4, a coil frame 4 forms a well 4a designed to receive a hair curler that is desired to be heated. The coil frame 4 also supports an induction coil comprising windings of wires therearound.

Attached to the lower housing 1c is an on/off switch 5 for applying and disconnecting power to the heater.

A wire coil 6 is wound about the coil frame 4 for creating an induction coil. The wire coil 6 typically includes multiple strands (for example, 20 strands) of enameled insulated wires. The wires are typically 0.3 mm in diameter and are twisted and wound upon the coil frame in a diameter of, for example, 100 mm with a typical thickness of 3 mm and length of 63 mm. The number of turns about the coil may vary, but are typically 26-28 turns.

A control circuit 7 is operatively connected to the wire coil 6. The control circuit may be typically a printed circuit board. This print-circuit board comprises:

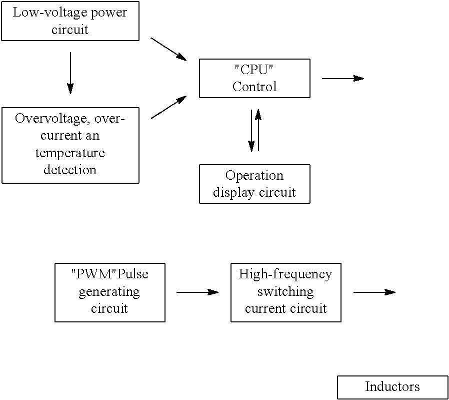

A micro-switch 8 connects the control circuit 7 to the coil frame 4. A resonant capacitor 9 is positioned between the middle housing 1b and the lower housing 1c and is operatively connected to the circuit board. The coil 6 is connected in parallel with the resonant capacitor 9 to create a resonant circuit. A heat sink 10 is housed in the lower housing 1c and is connected to the capacitor 9. Power to the heating unit 1 is supplied by a power cord connected to a suitable electrical connection 11 positioned in the lower housing 1c.

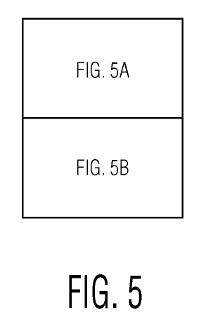

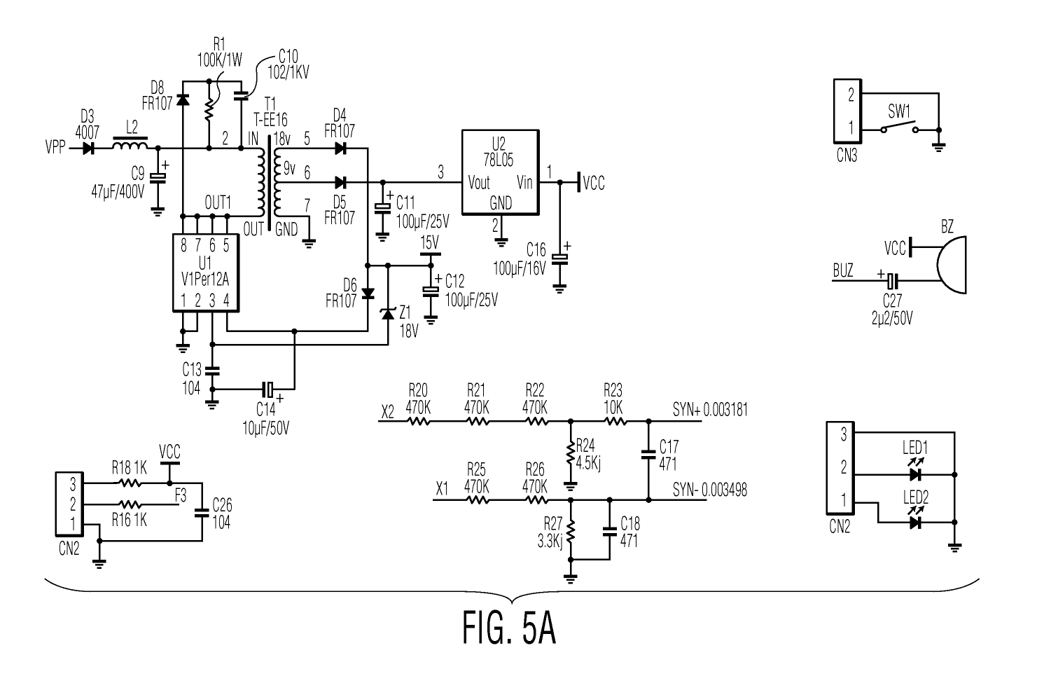

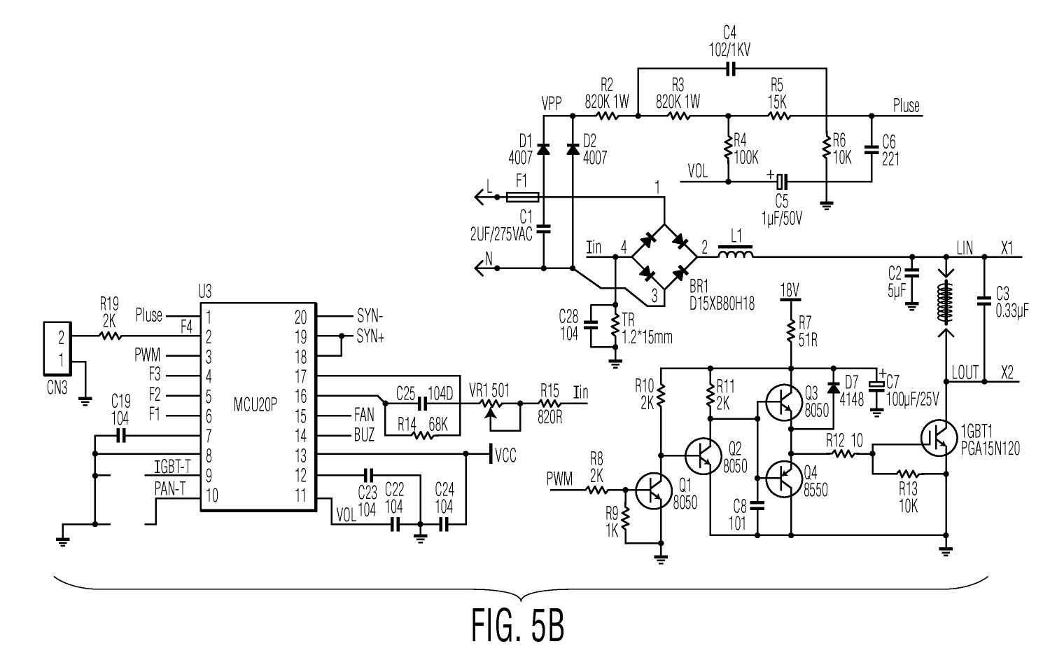

FIG. 5 schematically illustrates the electrical system of the present invention. The present invention is mainly designed to make on-off control on the resonant circuit by means of an Insulated Gate Bipolar Transistor (IGBT). Driven by the resonant circuit, the inductors form a high-frequency alternating current. The varying electric current passing through the inductors will generate varying magnetic lines of force, thus forming a magnetic field. Eddy currents inducted by magnetic lines of force are formed on the outer wall of a ferrous hair curler, and the electric impedances of these eddy currents against the ferrous hair curler convert electric energy into heat energy.

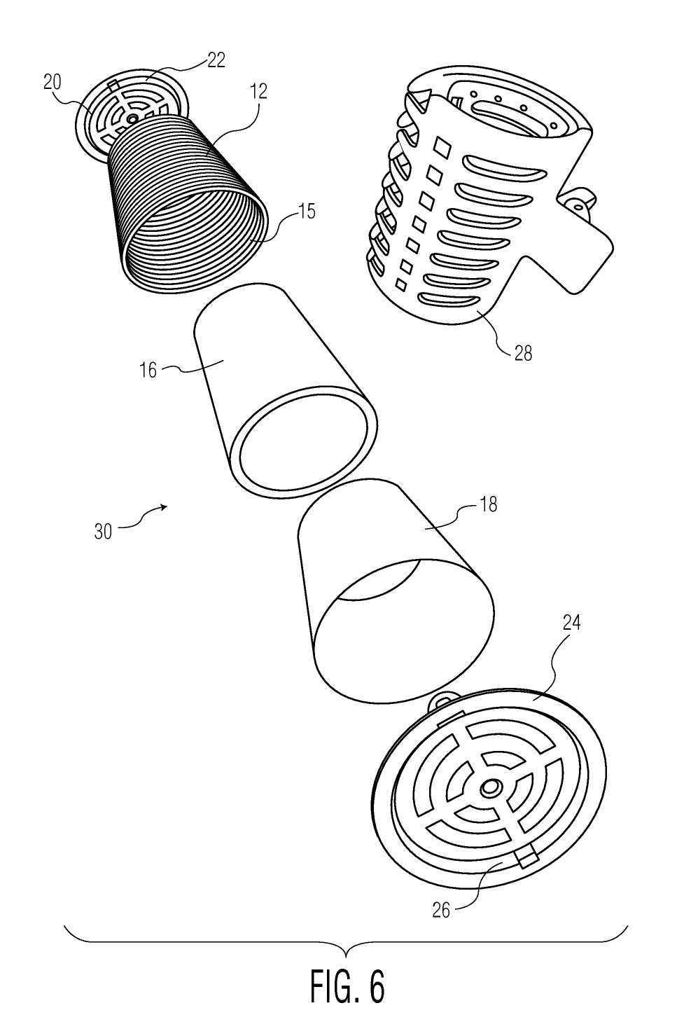

FIG. 6 shows an exploded view of a hair curler 30 of the present invention for being heated in the curler heater 1. A first conical member 12 has slits 15 extending therearound. Typically, self grip tape is used with the first conical member 12 for grabbing the hair just enough so that the fine hair is not snagged or teared.

A second conical member 16 fits substantially within the first conical member 12. The second conical member 16 consists essentially of silicon. A third conical member 18 fits substantially within the second conical member 16. The third conical member 18 comprises a ferro-magnetic material. A first end cap 20 fits on the end of the first conical member 12 and has substantially concentric slits 22. A second end cap 24 fits on the end of the third conical member 18 and also has substantially concentric slits 26 therein. A hair clamp 28 typically holds the wound hair to the hair roller. The hair clamp helps the hair rollers to retain heat and also to set the rollers in place.

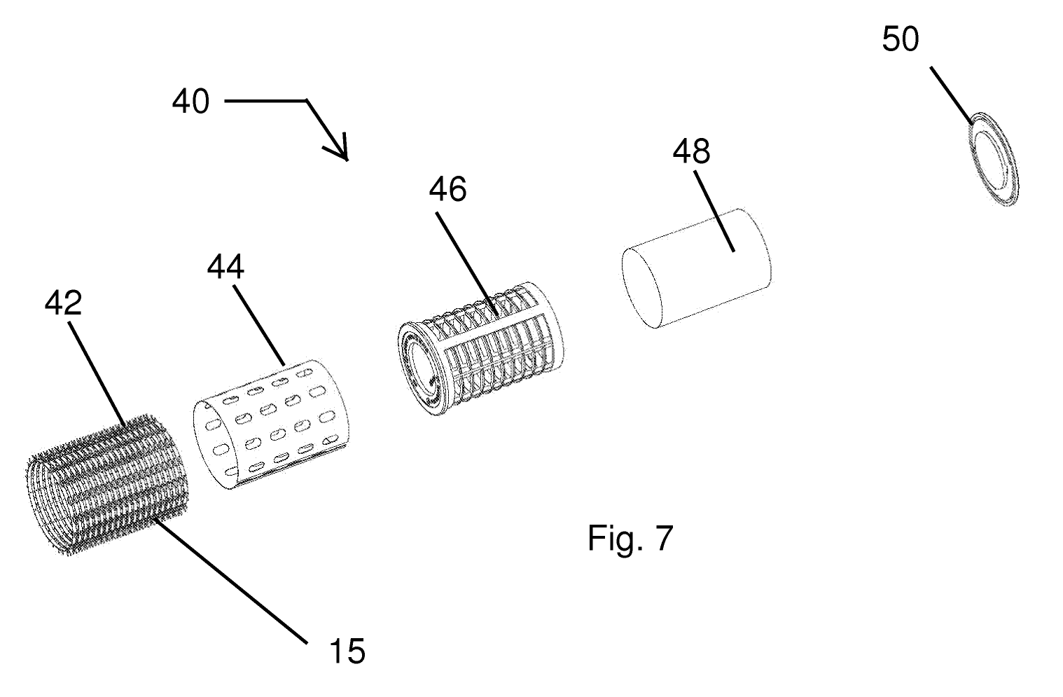

FIG. 7 shows an exploded view of another embodiment of the hair curler 40 of the present invention. In this embodiment, the component parts are less conical and more cylindrical in shape. A first conical member 42 has slits 15 extending therearound. Typically, a high frictional material, for example, self grip tape is used with the first conical member 42 for grabbing the hair just enough so that the fine hair is not snagged or teared. The self grip tape includes conductive material, for example, aluminum.

A second conical member 44 fits substantially within the first conical member 42. The second conical member 44 is of conductive material, for example, aluminum. A third conical member 46 fits substantially within the second conical member 44. The third conical member 46 may form a cage as depicted in FIG. 7 and comprise a high heat plastic polymer material. The high heat plastic polymer material can be welded to the self grip tape of the first conical member 42 using, for example, ultra sound. Additives can also be added to the third conical member so that the cage can be made to turn from opaque to a transparent color when heated. A fourth conical member 48 fits substantially within the third conical member. The fourth conical member 48 comprises an induction material, for example, a ferro-magnetic material such as an iron alloy. The fourth conical member preferably has an air space of from about 2 mm to about 3 mm between it and the third conical member. This air space is used as the insulator for storing and regulating heat in the curler. An end cap 50 fits on the end of the curler. The end cap 50 is preferably made of the same composition as the third conical member.

The foregoing members may be secured together with a sealed bottom. The plastic of the curler made be of a thermo-sensitive materials such that the color and/or transparency of the material (e.g., a thermo-sensitive plastic) changes as the temperature of the curler, and therefore the material, changes. In this manner, a user may be afforded a visual cue as to the relative temperature of the curler.

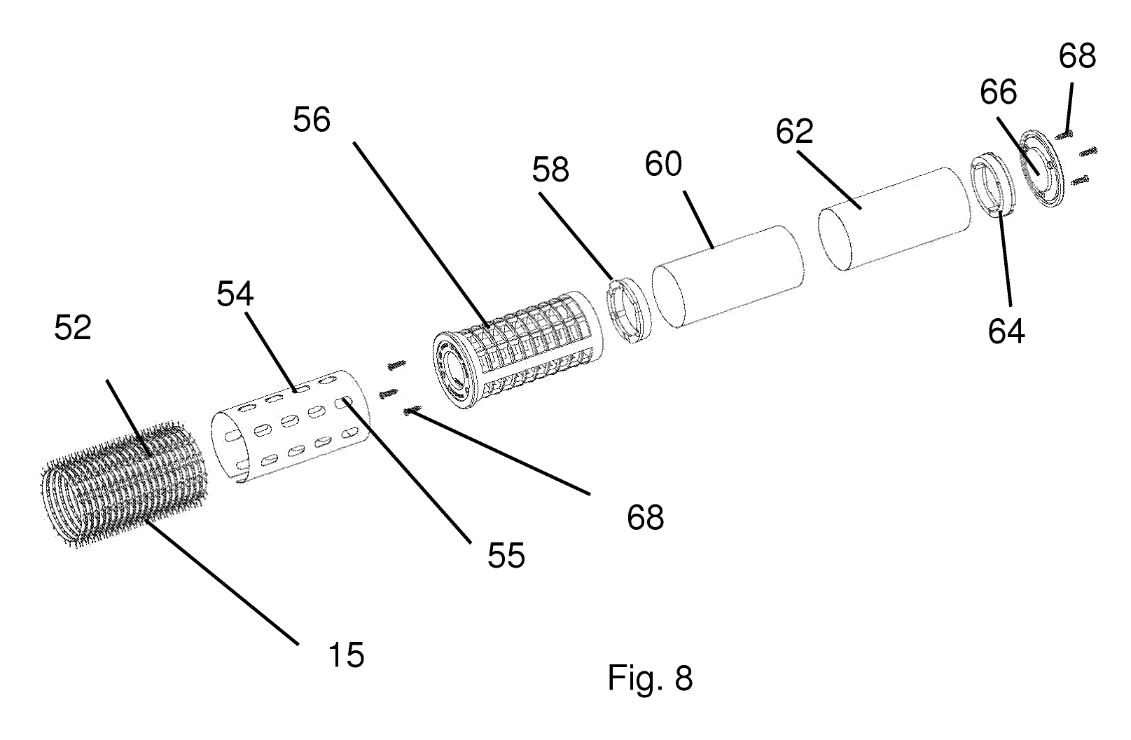

FIG. 8 shows an exploded view of yet another embodiment of the hair curler of the present invention. In this embodiment, similar to the embodiment depicted in FIG. 7, the component parts are less conical and more cylindrical in shape. A first conical member 52 has slits 15 extending therearound. Typically, a high frictional material, for example, self grip tape is used with the first conical member 52 for grabbing the hair just enough so that the fine hair is not snagged or teared. The self grip tape includes conductive material, for example, aluminum.

A second conical member 54 fits substantially within the first conical member 52. The second conical member 54 is of conductive material, for example, aluminum. The second conical member 54 may further include slits 55 extending a portion of its length. A third conical member 56 fits substantially within the second conical member 54. The third conical member 56 may form a cage as depicted in FIG. 8 and comprise a high heat plastic polymer material. The high heat plastic polymer material can be welded to the self grip tape of the first conical member 42 using, for example, ultra sound. Additives can also be added to the third conical member so that the cage can be made to turn from opaque to a transparent color when heated.

The first conical member 52 surrounding the second conical member 52 may be typically welded to the third conical member 56. Such welding may be accomplished using, for example, ultra-sound. Once welded, conical members 52, 54, and 56 become fixed to each other and cannot be taken apart unless they are broken.

A fourth conical member 60 fits substantially within the third conical member 56. The fourth conical member 60 comprises an induction material, for example, a ferro-magnetic material such as an iron alloy. The fourth conical member preferably has an air space of from about 2 mm to about 3 mm between it and the third conical member. This air space is used as the insulator for storing and regulating heat in the curler.

A fifth conical member 62 fits within the fourth conical member 60. The fifth conical member 62 comprises aluminum film. The aluminum assists in retaining heat. PBT material may be fixed to the aluminum film. The fifth conical member is held within the fourth conical member by rings 58 and 64. Rings 58 and 64 retain the fifth conical member within the fourth conical member so that a relatively constant space is kept between the outside diameter of the fifth conical member and the inside diameter of the fourth conical member. In this way, an annulus is formed between these two members.

Screws 68 may be used to connect the third conical member 56 to the ring 58.

An end cap 66 fits on the end of the curler. The end cap 66 is preferably made of the same composition as the third conical member. Screws 68 may be used to connect the end cap 66 to the third conical member.

The foregoing members may be secured together with a sealed bottom. The plastic of the curler made be of a thermo-sensitive materials such that the color and/or transparency of the material (e.g., a thermo-sensitive plastic) changes as the temperature of the curler, and therefore the material, changes. In this manner, a user may be afforded a visual cue as to the relative temperature of the curler.

A hair clamp typically holds the wound hair to the hair roller. The hair clamp helps the hair rollers to retain heat and also to set the rollers in place.

Typically, there are six sizes of hair curlers (in diameters of 26 mm, 32 mm, 38 mm, 46 mm, 52 mm and 58 mm). They are made of stainless iron sheet in thickness of 0.1 mm and length of 60 mm. Each hair curler has silicon film added to the exterior in a typical thickness of 1-1.5 mm, covered with nylon self grip tape, with its top and bottom being covered with polycarbonate plastic. Each size of roller will retain the same temperature of heat and for the same amount of time, controlled by the insulator inside the roller.

### Example

It is to be understood that the following example of the present invention is not intended to restrict the present invention since many more modifications may be made within the scope of the claims without departing from the spirit thereof.

In operation, an embodiment of the present invention operates as follows. When the power supply is switched on and two pole switches are turned on, power is on shown by a red display. When a big or small heat conducting heating curler is put into the well, a micro-switch in the well will be activated. If any ferromagnetic material is detected, a green lamp will blink and send an acoustic signal and will apply a high-frequency alternating current to the inductors. A magnetic field will be thus be generated in the well. If there is ferromagnetic material within the range of magnetic field, high frequency eddy currents will be generated in the magnetic field. Under the effect of the eddy currents, the heat conducting hair curler containing ferromagnetic material will generate heat. When the green lamp stops blinking and the acoustic signal ends, the heating has been stopped. The heat conducting hair curler can then be removed for use. Since the high frequency eddy current is still left in the heat conducting hair curler, it will slowly raise the temperature. When the temperature indicators have started to change color slowly (all four grids change color), it means that the heat conducting hair curler can no longer be heated until the four grids have turned to their primary colors.

The total time for registering whether an object in the well contains iron is typically 4 seconds. The total time for heating the curlers is typically 4 seconds.

The quick instant heat up of induction heating allows the user to place the curling roller into the heating well, wait for a total of 8 seconds, take the roller out and place another roller into the well in preparation for the next roll. The present invention heats up one roller at a time, eliminating the risk of having heated rollers sitting around. The roller is always freshly heated for styling.

The induction of the present invention also allows the roller to reach the maximum temperature not at the time of applying the hair roller, but shortly afterwards. This allows the user sufficient time to handle a mildly heated roller instead of a piping hot roller.

Although the particular embodiments shown and described above will prove to be useful in many applications in the heating hair styling arts to which the present invention pertains, further modifications of the present invention will occur to persons skilled in the art. All such modifications are deemed to be within the scope and spirit of the present invention as defined by the appended claims.

What is claimed is:

1. A hair curler, comprising:
a. a first conical member comprising a high frictional and conducting material therearound;
b. a second conical member fitting substantially within said first conical member comprising a conducting material;
c. a third conical member fitting substantially within said second conical member comprising a high heat plastic polymer;
d. a fourth conical member fitting substantially within said third conical member comprising an induction material; and
e. an end cap fitting on the end of the hair curler.

2. The hair curler of claim 1, wherein said end cap is of the same material as said third conical member.

3. The hair curler of claim 2, wherein the conducting material of said first conical member is aluminum.

4. The hair curler of claim 3, wherein the conducting material of said second conical member is aluminum.

5. The hair curler of claim 4, wherein said first conical member and said second conical member are welded to one another.

6. The hair curler of claim 5, wherein said third conical member is welded to said first conical member and said second conical member.

7. The hair curler of claim 6, wherein said welding is accomplished by ultra-sound welding.

8. The hair curler of claim 7, wherein said polymer material of said third conical member changes from opaque to a transparent when heated.

9. The hair curler of claim 7, wherein said polymer material of said third conical member changes from opaque to a transparent color when heated.

10. A hair curler, comprising:
a. a first conical member comprising a high frictional and conducting material therearound;
b. a second conical member fitting substantially within said first conical member comprising a conducting material;
c. a third conical member fitting substantially within said second conical member comprising a high heat plastic polymer;
d. a fourth conical member fitting substantially within said third conical member comprising an induction material;
e. a fifth conical member fitting substantially within said fourth conical member comprising an aluminum film; and
f. an end cap fitting on the end of the hair curler.

11. The hair curler of claim 10, further comprising a pair of rings for holding said fifth conical member within said fourth conical member.

12. The hair curler of claim 11, wherein said end cap is of the same material as said third conical member.

13. The hair curler of claim 12, wherein the conducting material of said first conical member is aluminum.

14. The hair curler of claim 13, wherein the conducting material of said second conical member is aluminum.

15. The hair curler of claim 14, wherein said first conical member and said second conical member are welded to one another.

16. The hair curler of claim 15, wherein said third conical member is welded to said first conical member and said second conical member.

17. The hair curler of claim 16, wherein said welding is accomplished by ultra-sound welding.

18. The hair curler of claim 17, wherein said polymer material of said third conical member changes from opaque to a transparent when heated.

19. The hair curler of claim 17, wherein said polymer material of said third conical member changes from opaque to a transparent color when heated.

20. A hair curling heating apparatus, comprising:
a. a hair curler, comprising:
i. a first conical member comprising a high frictional and conducting material therearound;
ii. a second conical member fitting substantially within said first conical member comprising a conducting material;
iii. a third conical member fitting substantially within said second conical member comprising a high heat plastic polymer;
iv. a fourth conical member fitting substantially within said third conical member comprising an induction material; and
v. an end cap fitting on the end of the hair curler; and
b. a housing for receiving said hair curler and for heating it therein, wherein said housing comprises:
i. an induction coil;
ii. a control circuit operatively connected to the coil;
iii. a resonant capacitor operatively connected to the circuit;
iv. a heat sink connected to the capacitor; and
v. a colored heating indication panel attached to the housing and operatively connected to the circuit,
wherein said curlers are inductively heated by said housing.
